(19) United States
(12) Patent Application Publication
(10) Pub. No.: US 2024/0023574 A1
(43) Pub. Date: Jan. 25, 2024

(54) Elderberry Extract Dog Treat

(71) Applicants: Teresa Kurowski, Spring Hill, TN (US); Steve Kurowski, Spring Hill, TN (US)

(72) Inventors: Teresa Kurowski, Spring Hill, TN (US); Steve Kurowski, Spring Hill, TN (US)

(21) Appl. No.: 17/868,103

(22) Filed: Jul. 19, 2022

(51) Int. Cl. A23K 10/30; A23K 40/20; A23K 50/42; A23K 30/20

(52) U.S. Cl. CPC A23K 10/30; A23K 40/20; A23K 50/42; A23K 30/20

(57) ABSTRACT

An elderberry extract dog treat includes 45-55% by weight elderberry syrup extract, 15-25% by weight chia seeds, 10-20% by weight oatmeal flour, and 5-15% by weight peanut butter.

### CROSS-REFERENCE TO RELATED APPLICATIONS

Not Applicable

### STATEMENT REGARDING FEDERALLY SPONSORED RESEARCH OR DEVELOPMENT Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to dog treats and more particularly pertains to a new dog treat for incorporating benefits of elderberry extract into a dog treat.

### (2) Description of Related Art Including Information Disclosed under 37 CFR 1.97 and 1.98

The prior art relates to dog treats. Known prior art fails to teach incorporation of elderberry extract into a dog treat.

### BRIEF SUMMARY OF THE INVENTION

An embodiment of the disclosure meets the needs presented above by generally comprising 45-55% by weight elderberry syrup extract, 15-25% by weight chia seeds, 10-20% by weight oatmeal flour, and 5-15% by weight peanut butter.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a schematic view of a dog treat according to an embodiment of the disclosure.

### DETAILED DESCRIPTION OF THE INVENTION

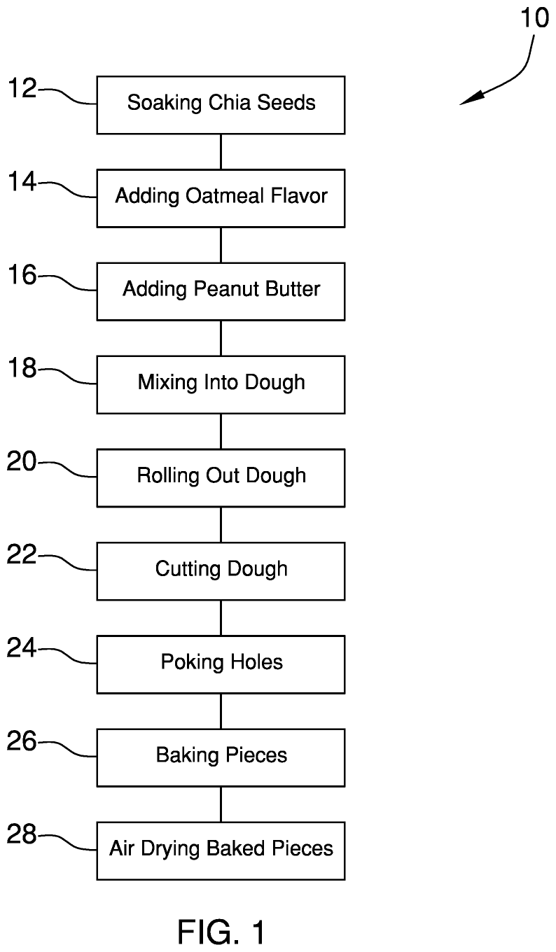

With reference now to the drawing, and in particular to FIG. 1, a new elderberry extract dog treat and method of making embodying the principles and concepts of an embodiment of the disclosure will be described.

As best illustrated in FIGS. 1 through 6, the elderberry extract dog treat generally comprises 45-55% by weight elderberry syrup extract, 15-25% by weight chia seeds, 10-20% by weight oatmeal flour, and 5-15% by weight peanut butter. More specifically, the proportions of ingredients may be 50% elderberry syrup extract, 20% chia seeds, 15% oatmeal flour, and 10% peanut butter, each by weight. The elderberry syrup extract may be of the type sold under the brand name Swanson Elderberry Extract Syrup. The oatmeal flour can be bought or made by grinding raw oatmeal into flour. The peanut butter may be any conventional peanut butter commercially available.

A method 10 of making the elderberry extract dog treats includes an initial step 12 of soaking the chia seeds in the elderberry syrup extract to form a gel. Another step 14 is adding oatmeal flour to the gel. Yet another step 16 is adding the peanut butter to form a mixture. A step 18 is mixing the mixture to form a dough. Step 20 is rolling out the dough. Step 22 is cutting the dough into pieces. Step 24 is poking a hole in each piece to allow moisture to vent from each piece through the hole during a step 26 of baking the pieces for 15 minutes at 375 degrees Fahrenheit. After baking, a step 28 is air drying for at least three hours.

In use, the baked and dried pieces may be fed to a canine as a treat which imparts known advantages of elderberry extract to the canine.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A dog treat comprising:
45-55% by weight elderberry syrup extract;
15-25% by weight chia seeds;
10-20% by weight oatmeal flour; and
5-15% by weight peanut butter.

2. The dog treat of claim 1, wherein the dog treat comprises:
50% by weight elderberry syrup extract;
20% by weight chia seeds;
15% by weight oatmeal flour; and
10% by weight peanut butter.

3. A method of making a dog treat, the steps of the method comprising:
soaking chia seeds in elderberry syrup extract until congealed into a gel;
adding oat flour to the chia seeds and elderberry syrup extract;
adding peanut butter to the oat flour, chia seeds, and elderberry syrup extract to form a mixture;
mixing the mixture to form a dough;
rolling out the dough;
cutting the dough into pieces;
poking a hole into each of the pieces;
baking the pieces for 15 minutes at 375 degrees Fahrenheit; and
air drying the pieces for at least three hours.

4. The method of claim 3, wherein the chia seeds are 15-25% by weight of the mixture, the elderberry syrup extract is 45-55% by weight of the mixture, the oatmeal flour is 10-20% by weight of the mixture, and the peanut butter is 5-15% by weight of the mixture.

5. The method of claim 3, wherein the chia seeds are 20% by weight of the mixture, the elderberry syrup extract is 50% by weight of the mixture, the oatmeal flour is 15% by weight of the mixture, and the peanut butter is 10% by weight of the mixture.
